(19) United States
(12) Patent Application Publication
(10) Pub. No.: US 2006/0114227 A1
(43) Pub. Date: Jun. 1, 2006

(54) Mouse

(76) Inventor: Yu-Teng Lin, Yunghe City (TW)

Correspondence Address: LEONG C LEI, PMB # 1008, 1867 YGNACIO VALLEY ROAD, WALNUT CREEK, CA, 94598, US

(21) Appl. No.: 10/986,327

(22) Filed: Nov. 12, 2004

(51) Int. Cl. G09G 5/08

(52) U.S. Cl. 345/163

(57) ABSTRACT

An improved construction of a mouse to provide more comfortable holding and prevent hand fatigue is comprised of a dome ergonomically designed and provided behind the keys, the dome being made of soft material including silica gel, or filled up with air, oil, water, emulsion or the like surrounded by hard wall at its root, or the dome being made slightly inclined forward to compromise the hollow of the palm.

### BACKGROUND OF THE INVENTION

(a) Technical Field of the Invention

The present invention is related to an improved construction of a mouse, and more particularly to one permits more comfortable holding and prevents from hand fatigue.

(b) Description of the Prior Art

Various types of mouse generally available in the market for the control of a computer operation have their ends provided with keys and a roller and the area behind made a smooth convex surface to facilitate the holding by the center of the palm of a user. However, the convex surface on the rear of the mouse does not fully comprise the center of the palm, and is made of hard plastic material to fail compliance with ergonomics. Therefore, the mouse of the prior art is not comfortable to hold, and after long hours of use, hand fatigue appears or injury is done to the hand in worse case. Although some mouses are provided with a transparent holding portion in which are fitted fish decoration, water and so on, they can only provide a novel appearance which is irrelevant with the comfort in holding.

### SUMMARY OF THE INVENTION

The primary purpose of the present invention is to provide an improved construction of a mouse that is more comfortable to hold and prevents hand fatigue after long hours of use. To achieve the purpose, the area of the mouse behind the keys is made in a shape of a dome surrounded at its root with a wall. The dome is made of soft material including silica gel, or filled with air, oil, water or emulsion, and may be provided in a semi-circular shape, or with a slope slightly inclined forward. The dome designed in compliance with ergonomics to fully compromise the shape of the center of the palm.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of a preferred embodiment of the present invention.

FIG. 2 is a side view of a preferred embodiment of the preferred embodiment of the present invention.

FIG. 3 is a schematic view showing the preferred embodiment of the present invention in use.

FIG. 4 is a side view of a second preferred embodiment of the present invention.

FIG. 5 is a schematic view showing the second preferred embodiment of the present invention in use.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

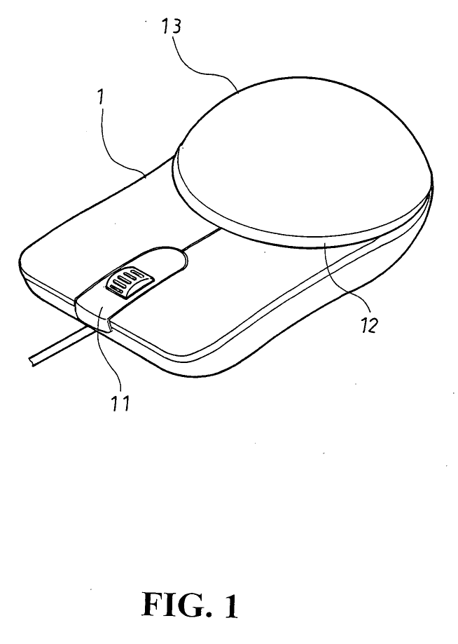

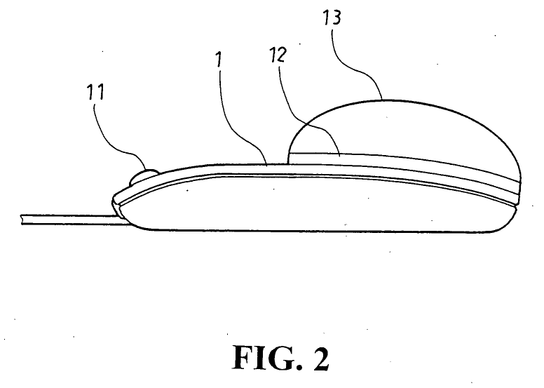

Referring to FIGS. 1 and 2, a first preferred embodiment of the present invention is essentially comprised of a mouse 1, two keys 11 in the front of the mouse 1; a dome 13 made of soft material is provided at where behind the keys 11; and a hard wall 12 surrounds at the root of the dome to facilitate the holding by the center of the palm of the user.

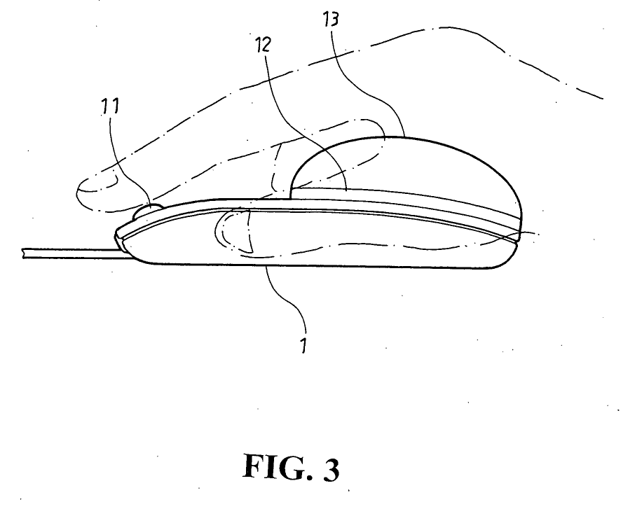

As illustrated in FIG. 3, upon holding the mouse 1, the dome 13 fully compromise the center of the palm and the dome to leave no space between the surface of the dome 13 and the center of the palm. As the dome 13 is made of soft material, it is easy and comfortable to hold in meeting the requirements of ergonomics, and further to prevent hand fatigue after long hours of using the mouse.

Alternatively, the dome 13 is filled up with air, oil, water, or emulsion for easy and comfortable holding.

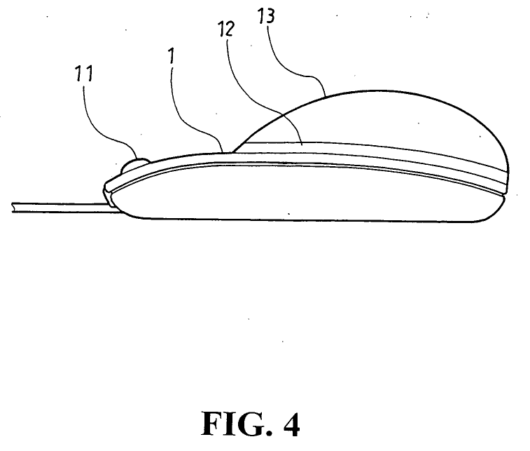

As illustrated in FIG. 4, the front of the dome 13 is extended slightly inclined forward up to the rear edge of the keys 11 for the fingers to fully rest on the inclined tip of the dome 13 to provide even more comfortable to hold.

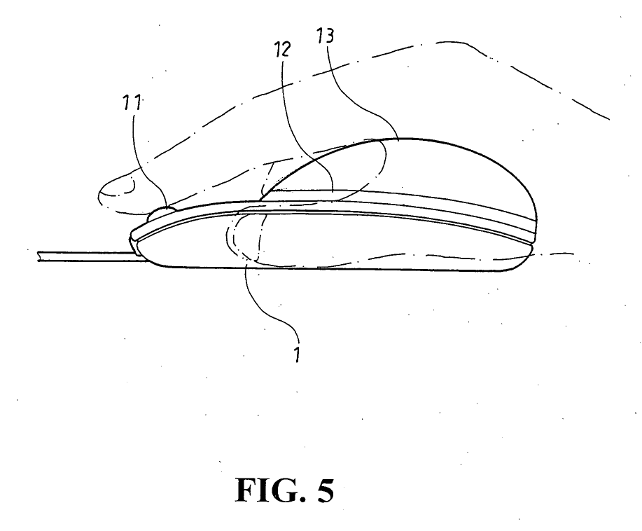

Now referring to FIG. 5, the extended part of the dome 13 is fully compromising the fingers that operate the keys 11 for the entire center of the palm to fully rest on the mouse 1 for easier and comfortable operation.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A mouse is comprised of the keys in the front and a dome behind the keys; the dome being made of soft material and surrounded at its root a hard wall; the dome compliant with ergonomics fully compromising the center of a palm for comfortable holding and preventing hand fatigue after long hours of use.

2. The mouse as claimed in claim 1, wherein the dome is made of silica gel.

3. The mouse as claimed in claim 1, wherein the dome is filled up with air, oil, water, or emulsion.
